(19) United States
(12) Patent Application Publication
(10) Pub. No.: US 2008/0124448 A1
(43) Pub. Date: May 29, 2008

(54) METHOD OF MAINTAINING THE STABILITY AND QUALITY OF FROZEN DESSERTS

(76) Inventors: James T.C. Yuan, Boothwyn, PA (US); Amit Vohra, Bear, DE (US)

Correspondence Address: AIR LIQUIDE;Intellectual Property, 2700 POST OAK BOULEVARD, SUITE 1800, HOUSTON, TX, 77056, US

(21) Appl. No.: 11/563,322

(22) Filed: Nov. 27, 2006

(51) Int. Cl. A23L 3/3409

(52) U.S. Cl. 426/654; 426/418

(57) ABSTRACT

Processes for maintaining the stability and quality of frozen desserts during storage and transportation, including an improvement. This improvement process involves flushing the ambient air in the storage compartment and flushing this storage compartment, with either a low molecular weight gas, a high molecular weight gas, or a combination of both. The gas mixture in the compartment would allow the cells within the frozen dessert to remain at approximately a constant volume during elevation changes, thereby reducing or eliminating shrinkage and transportation settling.

### BACKGROUND

Ice cream is, essentially, a foam consisting of air bubbles dispersed in a mixture of fat, water, and ice crystals. The air fraction is typically around 50% by volume, and this is crucial for the product to have the consistency and texture desired by customers.

The term “overrun”, is used to indicate how much air a particular ice cream contains. It is basically the ratio of the volume of the ice cream, less the volume of the liquid ice cream mix, divided by the volume of the liquid ice cream mix. So, if 50% of the volume of the ice cream is air, one would say that it had a 100% overrun.

U.S. federal standards limit the amount of air by specifying that a liter of ice cream must weigh at least 0.54 kilograms. U.S. ice creams, typically, do not contain over 100% overrun. Regular, to premium ice cream, generally, has 80%-100% overrun, and super premium ice cream often has 20%-50% overrun.

While recognizing that this large percentage of air must be incorporated into the final ice cream product, the main aim of ice cream manufacturing is to incorporate the smallest sizes and largest numbers of air bubbles, ice crystals, and fat globules, into an aqueous phase.

However, these colloidal components are inherently unstable, which leads to problems with maintaining the stability of ice cream structure, subsequent to manufacture.

In recent times, the stability of air cells within the ice cream product during storage and transportation, has been studied extensively by researchers. Sofjan and Hartel investigated the effect of overrun on air cell stability, and demonstrated that higher overrun led to slightly more stable air cells during storage. On the other hand, Chang and Hartel, as explained in their various publications, have studied the effects of operating conditions and formulation, as well as the type, level of emulsifier, and stabilizer, on the development of air cells during storage and hardening of dairy foams.

Commercially, different stabilizers, such as alginates, guar, locus bean, xanthan, carrageenan, and chemically modified cellulose gums (carboxymethylcellulose, CMC) are being used in combination. It has been found that this provides a more stable emulsion and helps prevent air bubble collapse/shrinkage during storage or transportation. Emulsifiers, such as a blend of propylene glycol monostearate, sorbitan tristearate, and unsaturated monoglycerides, EDTA, proteose peptone whey fraction, a mix of mono- and diglycerides (MDG), alone, or in combination with polysorbates, as well as polyglycerols and lecithin (or egg yolk), have also been used. These tend to establish and maintain a more stable structure around the air-cell walls. The incorporation of surfactants, such as Tween 60, has been shown to be effective in stabilizing air cells in ice creams.

However, despite these efforts, the problem of degradation of frozen desserts during the transportation or storage, due to pressure variations, owing to altitude changes still exists. Since trapped air bubbles (cells) form a significant portion of the total product volume, change in volume of trapped air bubbles, due to pressure variations, may lead to lids popping and leakage when shipped to high altitudes. On the other hand, product shrinkage occurs when shipped to low altitudes.

While ice cream has been discussed in detail, related issues are also found with the stability of other frozen desserts.

There is a need in the industry for a method to improve the stability and quality of frozen desserts.

### SUMMARY

The process in the present application is directed to a method to improve the stability and quality of frozen desserts.

In one aspect, a method of maintaining the stability and quality of aerated frozen desserts is provided. This method uses either a low molecular weight gas mixture, or a high molecular weight gas mixture, or a combination of both. This gas mixture is introduced into the storage compartment in which the frozen dessert is being transported.

### DESCRIPTION OF PREFERRED EMBODIMENTS

The pressure within the refrigerated transportation vehicle must be regulated with precision, as is indicated by the following examples:
a) An common elevation change of 500 feet (e.g. from Chicago to Houston), will result in an atmospheric pressure difference of 0.25 psia (or 6.9 inches of water);
b) A modest elevation change of 1000 feet (e.g. from Birmingham to New Orleans), will result in an atmospheric pressure difference of 0.5 psia (or 13.8 inches of water);
c) An elevation change of 3000 feet (e.g. from Los Angeles to San Jose), will result in an atmospheric pressure difference of 1.5 psia (or 41.4 inches of water);
d) A significant elevation difference of 4000 feet (e.g. from El Paso to Houston), will result in an atmospheric pressure difference of 2.0 psia (or 55.2 inches of water); and
e) An even more significant, but entirely possible, elevation difference of 5000 feet (e.g. from Albuquerque to Phoenix), will only result in an atmospheric pressure difference of 2.5 psia (or 69.0 inches of water).

Therefore, a pressure variation of about 2.5 psia or less, is the source of the problems with air cell growth and rupture that is leading to the shrinkage problems. It is clear that a pressure variation of 2.5 psia during shipping is far too extreme and must be reduced significantly.

One embodiment of a proposed solution to this problem may be understood by way of an example.

To start the analysis, assume that the gases involved obey the ideal gas law:

PV=(mRT)/M
Where
P=pressure
V=total volume
m=mass
R=universal gas constant
T=temperature
M=molecular weight

Therefore, if everything remains constant except for the pressure and the molecular weight, the volume would be:

V=constant/(PM).

Next, assume a maximum elevation change of 2000 feet occurs during transportation. Assume that the frozen dessert is manufactured at the point of lowest elevation, and that the point of highest elevation occurs during transportation. The frozen dessert will experience a decrease in pressure that will encourage the volume of the gases that have been whipped into the dessert to increase by almost 8%.

In this part of the example, assume that air has a molecular weight of approximately 29 kg/kmol. In order for the volume within the air cells in the frozen dessert to remain constant, between the base elevation and the highest elevation, a gas with a mean molecular weight of (1.08)×(29)=31.3 kg/mol, could be introduced into the compartment, thereby replacing the ambient air. This gas may be, for example, 47% carbon dioxide and 53% neon. This gas may also be, for example, 42% nitrogen and 58% nitrous oxide.

Thus, as the elevation change would cause the air within the frozen dessert to increase Its specific volume, the high molecular weight gas within the compartment would experience a greater change in specific volume, thereby increasing the relative pressure within the sealed compartment to that of the point of lowest elevation. This will result in the frozen dessert experiencing little or no pressure change during transportation.

Assume a maximum elevation change of 3000 feet occurs during transportation. Assume that the frozen dessert is manufactured at the point of highest elevation, and that the point of lowest elevation occurs during transportation. The frozen dessert will experience a decrease in pressure that will encourage the volume of the gases that have been whipped into the dessert, to decrease by almost 11%.

Assume that air has a molecular weight of approximately 29 kg/kmol. In order for the volume within the air cells in the frozen dessert to remain constant between the base elevation and the highest elevation, a gas with a mean molecular weight of (0.89)×(29)=25.8 kg/mol, could be introduced into the compartment, thereby replacing the ambient air. This gas may be, for example, 24% carbon dioxide and 76% neon. This gas may also be, for example, 30% nitrogen and 70% nitrous oxide.

Such an embodiment would allow for the maintenance of the aerated cell volume within the frozen dessert during the gradual ascents and descents that would be encountered during the transportation of the frozen desserts.

The low molecular weight gas mixture may be a mixture of any gases that has a mean molecular weight that is lower than that of air (i.e., 29 kg/kmol). The low molecular weight gas mixture may comprise one or more gases selected from the group consisting of air, helium, or mixtures thereof.

The high molecular weight gas mixture may be a mixture of any gases that has a mean molecular weight that is higher than that of air (i.e., 29 kg/kmol). The high molecular weight gas mixture may comprise one or more gases selected from the group consisting of air, carbon dioxide, nitrous oxide, argon, krypton, xenon, neon, or mixtures thereof.

The gas mixture may be a mixture of both, a low molecular weight gas mixture, and a high molecular weight gas mixture, as required by the type of frozen dessert.

In one embodiment, the storage compartment has a pressure relief device. This pressure relief device may be activated should the pressure within the storage compartment exceed the pressure at the lowest elevation experienced during transportation. This pressure relief device may be activated should the pressure within the storage compartment exceed a predetermined limit.

In one embodiment, the pressure relief device may be a spring-operated regulator. In another embodiment, the pressure relief device may be a control valve, where this control valve receives a signal form a pressure sensing device.

Illustrative embodiments have been described above. While the process in the present application is susceptible to various modifications and alternative forms, specific embodiments thereof have been shown by way of example in the drawings, and have been herein described in detail. It should be understood, however, that the description herein of specific embodiments is not intended to limit the process in the present application to the particular forms disclosed, but on the contrary, the process in the present application is to cover all modifications, equivalents, and alternatives falling within the spirit and scope of the process in the present application, as defined by the appended claims.

It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but, would nevertheless, be a routine undertaking for those of ordinary skill in the art, having the benefit of this disclosure.

What is claimed is:

1. A method of maintaining the stability and quality of aerated frozen desserts, comprising:
a) providing a storage compartment, placing said aerated frozen desserts within said storage compartment;
b) sealing said storage compartment; and
c) flushing said sealed storage compartment with at least one of a low molecular weight gas mixture and a high molecular weight gas mixture, maintaining at least one of a low molecular weight gas mixture and a high molecular weight gas mixture atmosphere in said sealed storage compartment during transportation of said aerated frozen desserts.

2. The method of claim 1, wherein said high molecular weight gas mixture has a mean molecular weight of approximately A×29 kg/kmol, wherein A is the ratio of the absolute atmospheric pressure at the location of the manufacture of the frozen dessert to the absolute atmospheric pressure at the lowest elevation encountered during transportation.

3. The method of claim 2, wherein said high molecular weight gas mixture comprises one or more of the gases selected from the group consisting of air, carbon dioxide, nitrous oxide, argon, krypton, xenon, neon or mixtures thereof.

4. The method of claim 1, wherein said low molecular weight gas mixture has a mean molecular weight of approximately B×29 kg/kmol, wherein B is the ratio of the absolute atmospheric pressure at the location of the manufacture of the frozen dessert to the absolute atmospheric pressure at the highest elevation encountered during transportation.

5. The method of claim 4, wherein said low molecular weight gas mixture comprises one or more of the gases selected from the group consisting of air, helium, or mixtures thereof.

6. The method of claim 1, wherein said storage compartment further comprises a pressure relief device.

7. The method of claim 6, wherein said pressure relief device is a spring-operated regulator.

8. The method of claim 6, wherein said pressure relief device is a control valve, wherein said control valve receives a signal from a pressure sensing device.
